(19) United States
(12) Patent Application Publication
(10) Pub. No.: US 2021/0154840 A1
(43) Pub. Date: May 27, 2021

(54) Movement Planning For Autonomous Robots

(71) Applicant: Robart GmbH, Linz (AT)

(72) Inventors: Reinhard Vogel, Linz (AT); Harold Artes, Linz (AT); Christoph Freudenthaler, Linz (AT); Ivo Knittel, Linz (AT)

(73) Assignee: Robart GmbH, Linz (AT)

(21) Appl. No.: 16/642,285

(22) PCT Filed: Aug. 31, 2018
(86) PCT No.: PCT/EP2018/073497

§ 371 Date: Jan. 25, 2021

(30) Foreign Application Priority Data
Sep. 1, 2017 (DE) 10 2017 120 218.8

(51) Int. Cl. B25J 9/16

(52) U.S. Cl. CPC B25J 9/1666

(57) ABSTRACT

The embodiments described herein relate, inter alia, to a method for controlling an autonomous mobile robot which can operate in a first and at least one second contour-following mode, wherein, in each of the contour-following modes, the robot maintains a substantially constant distance away from a contour while it moves along the contour. According to one exemplary embodiment, the method comprises the following: starting the first contour-following mode, in which the robot follows the contour in a first direction of travel; detecting a dead-end situation, in which it is not possible to continue following the contour in the first contour-following mode without collision; starting a second contour-following mode, in which the robot follows the contour in a second direction of travel; and defining a criterion, the fulfilment of which terminates the second contour-following mode, and continually evaluating the criterion while the robot operates in the second contour-following mode.

### TECHNICAL AREA

The description relates to the area of autonomous mobile robots, particularly the planning and implementing of movements of an autonomous mobile robot of the general type.

### BACKGROUND

Mobile robots, especially service robots, have been used with increasing frequency in the household sector in recent years, for example for cleaning or monitoring a home. The robots often have a round shape and a drive unit which enables them to rotate about a vertical axis. This simplifies path planning (trajectory planning) and control of these robots significantly, because their rotational degree of freedom is never limited by neighboring obstacles.

Due to the special requirements placed on the function of the robot, it may be desirable to deviate from the round (disc-shaped) shape. For example, the otherwise round shape of the robot may be flattened on one side such that the robot can move with the flat side parallel to a wall. For example, a cleaning unit (e.g. a brush) may be arranged on the flat side so that it can be guided as closely as possible to the wall. It may also be necessary or desirable to deviate from a round structure of the robot for other reasons.

A structure that is not round in relation to the base area of the robot may mean that the robot cannot rotate in place in every situation even if its drive unit essentially enables this. If the robot is positioned with its flat side very close to an obstacle (e.g. a wall), as in the previous example, the robot can no longer rotate as desired about its vertical axis without colliding with the obstacle. For planning and evaluating the movement options of the robot, the orientation of the robot thus must also be considered, in addition to the position of obstacles and of the robot in the robot's operational area. One approach for bypassing this problem is to use standard movement patterns for predefined situations. However, this approach is inflexible and prone to errors. In addition, it is difficult to predict all of the possible situations an autonomous robot may get into. A further approach is the precise planning of the movement of the robot, i.e. the change in position and orientation (jointly also known as pose) in order to go from a starting point to a target point. However, this is significantly more difficult than it is for a round robot, whereby the incidence of errors during implementation and the use of resources (computing time, processor capacity, memory requirements) increases for the necessary calculations.

The object of the invention is to enable simple but robust planning for the movement of an autonomous mobile robot of any shape.

### ABSTRACT

The aforementioned object is achieved by means of the methods according to claims 1, 16, 28, 45, and 50. Various exemplary embodiments and refinements are the subject matter of the dependent claims.

The invention relates to a method for controlling an autonomous mobile robot which can operate in a first and at least one second contour-following mode, wherein, in each of the contour-following modes, the robot maintains a substantially constant distance away from a contour while it moves along the contour. According to one exemplary embodiment, the method comprises the following: starting the first contour-following mode, in which the robot follows the contour in a first direction of travel; detecting a dead-end situation, in which it is not possible to continue following the contour in the first contour-following mode without collision; starting a second contour-following mode, in which the robot follows the contour in a second direction of travel; and defining a criterion, the fulfilment of which terminates the second contour-following mode, and continually evaluating the criterion while the robot operates in the second contour-following mode.

Furthermore, a method for controlling an autonomous mobile robot in a contour-following mode is described, in which the robot substantially follows a contour at a contour-following distance. According to one exemplary embodiment, the method in contour-following mode consists of the following: evaluating at least three different basic movements by means of at least one definable criterion as well as executing one of the three basic movements based on the evaluation thereof. The first of the three basic movements is a purely translational movement of the robot; the second of the three basic movements includes a rotation of the robot toward the contour; and the third of the three basic movements involves a rotation of the robot away from the contour.

Moreover, a method for controlling an autonomous mobile robot is described, which has a first map of a robot's operational area, wherein said map at least contains data regarding the position of obstacles. According to one exemplary embodiment, the method comprises the planning of a path to a target point in the first map under the assumption of a simplified virtual shape of the robot. In some exemplary embodiments, the method may further comprise the following: movement of the robot along the planned path; recording of obstacles in the environment of the robot by means of a sensor unit of the robot, during which the robot moves along the planned path; and finally determining that the planned path cannot be traveled without collision due to an obstacle, while noting the actual robot shape; and continuing the movement of the robot while observing the actual robot shape.

Furthermore, a method for controlling an autonomous mobile robot with the aid of a map of the robot's operational area is described, wherein the map at least contains information regarding the position of real obstacles detected by means of a sensor unit as well as information on virtual obstacles. According to one exemplary embodiment, the method comprises controlling the robot in the vicinity of a real obstacle such that collision with the real obstacle is avoided, wherein the actual shape of the robot is considered; and controlling the robot in the vicinity of a virtual obstacle such that a collision with the virtual obstacle is prevented, wherein a simplified, virtual shape of the robot is considered.

Furthermore, a method for controlling an autonomous mobile robot in a contour-following mode is described, in which the robot substantially follows a contour at a contour-following distance. A robot map contains at least information on the position of real obstacles detected by means of a sensor unit as well as information on virtual obstacles. The robot is continually determining its position in said map, wherein the robot moves along a contour in the contour-following mode; and the contour is defined by the course of a real obstacle and the course of a virtual boundary of a virtual obstacle.

### BRIEF DESCRIPTION OF THE DRAWINGS

Various exemplary embodiments are explained in greater detail in the following by means of figures. The representations are not necessarily true-to-scale and the invention is not limited to only the aspects shown. Instead, more focus is placed on showing the underlying principles. The figures show the following:

FIG. 1 illustrates two examples of an autonomous mobile robot, in which one side is flattened such that the robot can move very closely along an obstacle, e.g. a wall, with its flat side.

FIG. 2 shows an example of the structure of an autonomous mobile robot using a block diagram.

FIG. 3 shows different variants of the housing shapes for autonomous mobile robots and illustrates the effect of the shape of the housing on the options the robot has for movement.

FIG. 4 illustrates a method for controlling an autonomous mobile robot in a dead-end situation by means of a flowchart.

FIG. 5 illustrates an exemplary procedure for controlling an autonomous mobile robot in a dead-end situation by means of four diagrams (a) to (d).

FIG. 6 illustrates an exemplary method for controlling an autonomous mobile robot in a dead-end situation.

FIG. 7 illustrates a further, more complex example of a method for controlling an autonomous mobile robot in a more complicated dead-end situation.

FIG. 8 shows examples of various basic movements.

FIG. 9 shows a simple example of selecting a basic movement.

FIG. 10 shows the movement of basic movements based on the environment.

FIG. 11 illustrates a contour-following run with virtual obstacle.

FIG. 12 illustrates the path planning of a round robot between obstacles; this is equivalent to path planning for a point between obstacles, which have been enlarged respectively about the robot radius.

FIG. 13 shows an example of cost-based path planning.

### MORE DETAILED DESCRIPTION

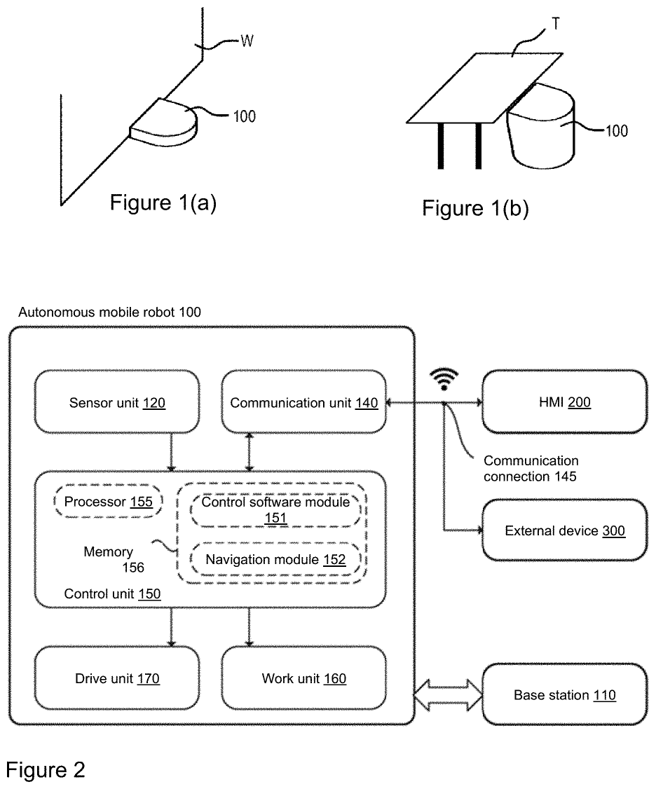

Due to the special requirements placed on the function of a robot 100, it may be desirable or necessary to deviate from a substantially round, disc-shaped housing of the robot. FIG. 1 shows two examples of this: Diagram (a) in FIG. 1 shows an autonomous mobile robot 100 for cleaning a surface area (cleaning robot). One side of the robot housing is flattened such that the robot 100 can align itself with the flat side parallel to a wall W. Diagram (b) in FIG. 1 shows a further example with an autonomous mobile robot 100 for transporting objects (service robot) with a platform which can be moved flush with respect to the edge of a table T or a working surface. The examples shown make it clear that robots designed in this manner cannot rotate in place about their vertical axis in every situation even if their drive units essentially would make this possible. In the situations shown in FIG. 1, the robot 100 cannot rotate without colliding with the obstacle (wall W, table T). This fact has effects on movement planning of the robot 100, because the orientation of the robot must also be considered when planning a trajectory from a starting point to a target point within the robot's operational area.

Before movement planning for autonomous mobile robots is addressed in more detail, the structure of an autonomous mobile robot should first be described. FIG. 2 shows an example, by means of a block diagram, of various units (modules) of an autonomous mobile robot 100. One unit and/or one module in this case may be an independent assembly or a part of software for controlling the robot. One unit may have multiple subunits. The software responsible for the robot's 100 behavior can be run by the control unit 150 of the robot 100. In the example shown, the control unit 150 contains a processor 155, which is configured to execute software instructions contained in a memory 156. Some functions of the control unit 150 can also be executed, at least partially, with the aid of an external computer. This means that the computing capacity required by the control unit 150 may be transferred, at least partially, to an external computer, which can be accessed, for example, from a home network or the Internet (cloud).

The autonomous mobile robot 100 comprises a drive unit 170, which may have, for example, electric motors, gears, and wheels, whereby the robot 100 can approach, at least theoretically, any point of an operational area. The drive unit 170 is configured to execute commands or signals received by the control unit 150 in the form of a movement of the robot 100.

The autonomous mobile robot 100 furthermore comprises a communication unit 140 for establishing a communication connection 145 with a human-machine interface (HMI) 200 and/or other external devices 300. For example, the communication connection 145 is a direct wireless connection (e.g. Bluetooth), a local wireless network connection (e.g. WLAN or ZigBee), or an Internet connection (e.g. to a cloud service). The human-machine interface 200 can provide a user with information regarding the autonomous mobile robot 100, for example in visual or even acoustic form (e.g. battery status, current work order, map information such as a cleaning map, etc.) and receive user commands for a work order for the autonomous mobile robot 100. Examples of an HMI 200 include a tablet PC, smartphone, smartwatch, and other wearables, computer, smart TV, or head-mounted displays, etc. An HMI 200 can additionally or alternatively be integrated directly into the robot, whereby the robot 100 can be operated, for example, via keyboards, gestures, and/or speech input and output.

Examples of external devices 300 are computers and servers, to which calculations and/or data are supplied, external sensors, which provide additional information, or other household devices (e.g. other autonomous mobile robots), with which the autonomous mobile robot 100 can work or exchange information.

The autonomous mobile robot 100 may have a work unit 160 such as, for example, a processing unit for processing a surface area and particularly for cleaning a surface area (e.g. brush, suction device) or a gripping arm for grasping and transporting objects.

In some cases, such as, for example, with a telepresence robot or a surveillance robot, a different unit is used for fulfilling the intended tasks, and a work unit 160 is not necessary. Thus, a telepresence robot may have a communication unit 140 coupled to the HMI which may be equipped, for example, with a multimedia unit, which may comprise, for example, a microphone, camera, and monitor, in order to enable communication between several people some spatial distance apart. A surveillance robot determines unusual events (e.g. fire, light, unauthorized persons, etc.) on monitoring runs with the aid of its sensors and reports back, for example, to a control center. In this case, a monitoring unit is provided with sensors for monitoring the robot's operational area instead of the work unit 160.

The autonomous mobile robot 100 comprises a sensor unit 120 with different sensors, for example one or more sensors for recording information about the environment of the robot in its operational area such as, for example, the position and extent of obstacles or other landmarks in the operational area. Sensors for recording information about the environment, for example, are sensors for measuring distances from objects (e.g. walls or other obstacles, etc.) in the environment of the robot such as, for example, an optic or acoustic sensor which can measure distances by means of triangulation or travel-time measurement of an emitted signal (triangulation sensor, 3D camera, laser scanner, ultrasound sensors, etc.). Alternatively or additionally, a camera can be used to collect information about the environment. The position and extent of an object can likewise be determined, particularly when an object is observed from two or more positions.

In addition, the robot may have sensors in order to detect (usually unintentional) contact (or collision) with an obstacle. This can be implemented using accelerometers (which detect, e.g., the change in speed of the robot in the event of a collision), contact switches, capacitive sensors, or other tactile and/or touch-sensitive sensors. In addition, the robot may have floor sensors in order to detect an edge in the floor, for example a stairstep. Further typical sensors in the autonomous mobile robot sector are sensors for determining the speed and/or the distance traveled by the robot such as, e.g., odometers and/or inertial sensors (acceleration sensor, rotational speed sensor) for determining changes in position and movement of the robot as well as wheel contact switches in order to detect contact between the wheel and the floor.

The autonomous mobile robot 100 may be assigned to a base station 110, at which it can charge its energy storage units (batteries) for example. The robot 100 can return to this base station 110 after completing a task. Once the robot has no further tasks to process, it can wait for a new task at the base station 110.

The control unit 150 may be designed to provide all the functions the robot needs in order to autonomously move into its operational area and to perform a task. To this end, the control unit 150 comprises, for example, the processor 155 and the memory module 156 in order to run software. Based on the information obtained by the sensor unit 120 and the communication unit 140, the control unit 150 can generate control commands (e.g. control signals) for the work unit 160 and the drive unit 170. As previously explained, the drive unit 170 can convert these control signals and/or control commands into a movement of the robot. The software contained in the memory 156 may also be modular. A navigation module 152 provides, for example, functions for automatic creation of a map of the robot's operational area as well as for movement planning of the robot 100. The control software module 151 provides, for example, general (global) control functions and may form an interface between the individual modules.

To ensure that the robot can autonomously perform a task, the control unit 150 comprises functions for navigation of the robot in its operational area, said functions being provided by the previously mentioned navigation module 152. These are known functions and may comprise, inter alia, one of the following:
creating (electronic) maps by collecting information about the environment with the aid of the sensor unit 120, for example but not exclusively by means of the SLAM method (Simultaneous Localization and Mapping);
managing one or more maps involving one or more operational areas of the robot assigned to one or more maps;
determining the position and orientation (pose) of the robot in a map based on the environment information determined with the sensors from the sensor unit 120;
map-based path planning (trajectory planning) of a current pose of the robot (starting point) to a target point;
a contour-following mode, in which the robot (100) moves along the contour of one or more obstacles (e.g. a wall) at a substantially constant distance d away from said contour.

With the aid of the navigation module 152 and based on the information from the sensor unit 120, the control unit 150 can continually update a map of the robot's operational area, for example, during operation of the robot, e.g. if the environment of the robot changes (obstacle is moved, door is opened, etc.). A current map can then also be used by the control unit 150 for short-term and/or long-term movement planning for the robot. The planning horizon can be any path that the control unit 150 calculates ahead of time to perform a (target) movement of the robot before it is actually executed. The exemplary embodiments described herein relate, inter alia, to various approaches and strategies for movement planning in certain situations, e.g. in situations in which certain maneuvers are blocked by obstacles and thus cannot be executed.

In general, a (electronic) map usable by the robot 100 is a collection of map data (e.g. a database) for storing location-based information about an operational area of the robot and the environment relevant to the robot in this operational area. In this context, “location-based” means that the stored information is assigned to a position or a pose in a map. Thus, a map represents a plurality of data sets with map data, and the map data may contain any sort of location-based information. In this case, the location-based information may be stored at different levels of detail and abstraction, wherein it can be adapted to a specific function. In particular, individual pieces of information can be stored redundantly. Frequently, a compilation of several maps related to the same area can be stored but in different format (data structure); this is also characterized as “a map.”

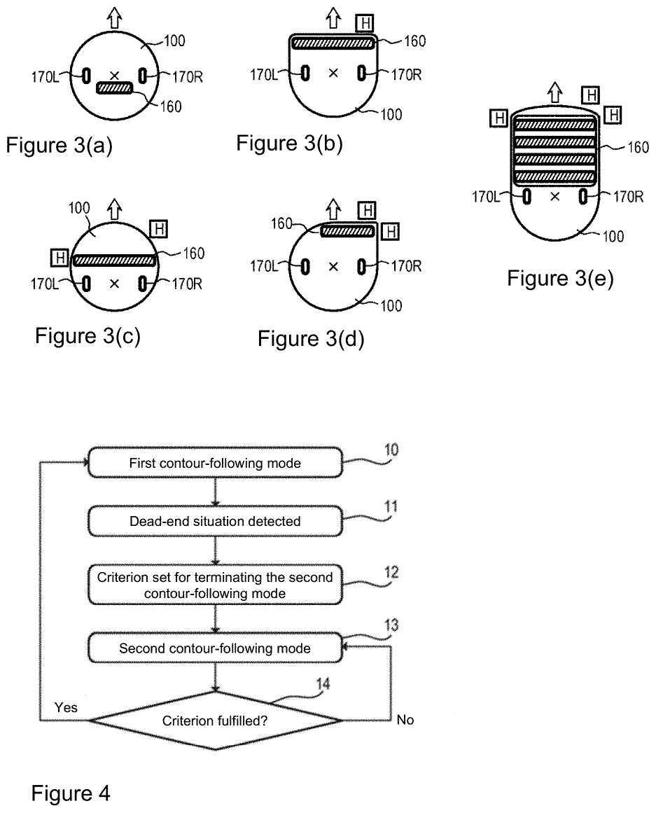

Non-round robots—introduction: FIG. 3 shows, in respective views from below, various known examples of housing shapes for autonomous mobile robots 100. In the examples shown, the robots 100 each have a work unit 160, for example to process a surface area, such as particularly a brush, a suction unit, and/or a wiping unit.

Furthermore, the robots 100 each have a drive unit 170 with two wheels 170R, 170L driven independently of one another. In general, mobile robots may have a preferred direction of travel (defined as a forward direction without limiting the generality), which is indicated by an arrow. This preferred direction of travel and/or forward direction may be defined by the arrangement of the work unit in or on the housing but also by the arrangement of sensors (e.g. the sensor unit 120). For example, a cleaning unit can be attached upstream of the drive unit 170 to handle dirt (e.g. suction device) so that less dirt gets into the wheels. Furthermore, a cleaning unit, for example, for applying a cleaning liquid or for polishing a surface area, can be attached downstream of the drive unit 170 so that the wheels do not leave any dirt behind on the cleaned surface area. For example, sensors are arranged such that they primarily detect the environment in the preferred direction of travel of the robot (i.e. in front of the robot 100). However, the robot 100 can also move opposite (i.e. backward) the preferred direction of travel (under some circumstances with certain limitations). With respect to the aforementioned preferred direction—even with robots essentially having a round shape (when viewed from above)—the orientation of the robot in a particular position plays a role and rotational movements, such as toward a contour (e.g. a wall) and away from a contour, can be clearly differentiated, even if the position of the robot does not change (upon a rotation about the axis of symmetry).

When the two driven wheels 170R, 170L rotate in the opposite direction, the robot rotates in place about the central point marked by an “×” (kinematic center, center of rotation) about its vertical axis and thus executes a purely rotational movement (i.e. without translational movement components).

Diagram (a) from FIG. 3 shows a round robot, the wheels 170R and 170L of which are arranged in one of the axes of symmetry. This has the advantage that the robot can rotate in place about its center. Regardless of the position of obstacles H, this rotation is never disturbed, which is why the round robot can always move in a preferred direction (i.e. forwards) after a suitable rotation about its vertical axis.

Diagram (b) from FIG. 3 shows a D-shaped robot. The D-shape has the advantage that a work unit 160 can be used which extends over the entire width of the robot. In addition, the work unit 160 can be moved particularly close to obstacles H (such as a wall, for example). In the pose shown here, however, the robot can no longer move without collision; it first must move at least a bit backwards (opposite the preferred direction of travel) before a rotation about its vertical axis.

Diagram (c) from FIG. 3 shows a round robot, the wheels 170R and 170L of which are not arranged along one of the axes of symmetry. This has the advantage that the work unit 160 can extend over the entire width of the robot. However, the central point “×” (kinematic center) of the robot 100 will no longer match the geometric center of the round base area of the housing, which is why there may be a collision with an obstacle H during a rotation. To prevent such collisions as in diagram (c) from FIG. 3, the robot must first move at least a bit backwards. In this example, the robot cannot execute a purely rotational movement easily. A rotation about the kinematic center “×” means that the movement of the geometric center also has a translational movement component (particularly movement in a circle about the kinematic center), which could possibly be blocked by an obstacle.

Diagram (d) from FIG. 3 shows a droplet-shaped housing of a robot 100, in which the base area of the housing has a pronounced corner but is otherwise round. This has the advantage that a work unit 160 can be arranged in the corner of the robot, and thus it can be guided close to obstacles (e.g. into the corner of a room). The movement of the robot is not as severely limited as with the D-shape. However, even in this case there are situations in which the robot must move at least a bit backwards before a rotation about the vertical axis is possible unimpeded.

Diagram (e) from FIG. 3 shows an elongated substantially D-shaped robot. This has the advantage that there is more room for a work unit 160 which can extend over the entire width of the robot. In addition, the work unit 160 can be guided particularly close to obstacles H such as a wall. In this position, the robot can no longer rotate, however, and must first move backward at least a bit.

A situation in which the robot, as shown in diagrams (b) to (e) of FIG. 3, can only extricate itself by moving in the backward direction (opposite the preferred direction of travel) is characterized in the following as a “dead-end situation.” It should be noted that the robots shown in FIG. 3 are merely examples. Obviously, other shapes are possible as desired. In particular, the shape may also vary with the height of the robot (cf. diagram (b) in FIG. 1). Other variants of the drive module 170 (such as chain drive, leg, for example) are likewise known and possible.

Contour following run: A simple approach to local planning of a path (a trajectory) for an autonomous mobile robot 100 is that the robot simply follows a contour of one or more obstacles (contour-following run) at a substantially constant contour-following distance d. An operating mode in which the robot is moved, oriented based on a contour of an obstacle, along a contour at a substantially constant distance is characterized in the following as contour-following mode or obstacle-following mode. The movement executed by the robot in contour-following mode is characterized as a contour-following run, and the distance away from the contour is characterized as the contour-following distance. The use of a contour-following mode is known and it is used, for example, to avoid obstacles (see, e.g., J. Fasola et al., “Fast Goal Navigation with Obstacle Avoidance using a Dynamic Local Visual Model,” in: Proc. VII. Simpósio Brasileiro de Automação Inteligente, São Luis, Sept. 2005). Methods for implementing contour-following runs can be based, inter alia, on the concepts of behavior-based robotics or reactive robotics, wherein current sensor measurements (particularly regarding the position of an obstacle relative to the robot and/or the distance of the robot away from an obstacle) can be implemented directly into control commands for the drive unit.

The contour may be defined by the shape of a wall, by a large obstacle, but also by several small obstacles close together. An edge over which a robot can crash (drop-off edge), such as a stairstep, for example, is also considered in this context to be an obstacle with a contour which the robot can follow. In addition, the contour-forming obstacles may be markings (for example in the form of magnetic strips, current loops, or beam transmitters) which the robot can detect with a corresponding sensor. A boundary (e.g. the course of the magnetic strip and/or the current loop, course of the emitted light beam) which the robot cannot cross over autonomously can be derived from this sensor data. This boundary can also be used as the contour which the robot can follow. Furthermore, virtual obstacles can be shown in the map data; these obstacles indicate areas which the robot is not allowed to enter autonomously (also characterized as blocked-off areas, keep-out areas, or no-go areas). Additionally or alternatively, a virtual obstacle and particularly its virtual contour can be temporarily used to confine the robot to an area intended for processing or to guide it until the processing is complete. The virtual contours of such a virtual obstacle can likewise be used as a contour the robot can follow in a contour-following mode.

The contour-following distance d is dependent on the size and the task of the robot; however, it can remain substantially constant in a specific contour-following mode. Unintentional collisions, for example due to driving errors, are easier to avoid (with greater probability) with a greater distance. A contour-following mode can be used for processing close to walls and other obstacles with robots intended to process (especially clean) a surface area. Consequently, such robots can move very close to obstacles in order to achieve high surface-area coverage and particularly a thorough cleaning in corners and at edges. Exemplary values for small cleaning robots in the household sector are between 2.5 mm and 20 mm in this case. There are also cleaning robots which establish and maintain direct contact (i.e. through touch) between a part of the robot and the contour to be followed during a contour-following run. For large robots, the contour-following distance d may be significantly greater than with comparable small robots.

In order to control the robot during a contour-following run, the robot may have sensors for detecting the direct environment of the robot (see FIG. 2, sensor unit 120). These sensors can reliably determine at close range, for example, distances away from obstacles and particularly from the contour to be followed. For example, such a sensor can be arranged on the particular side of the robot that is facing the contour to be followed.

Alternatively or additionally, the control of the robot during a contour-following run can be based on map data, wherein sensor measurements are stored and further processed for determining the position and orientation (pose) of the robot and of obstacles. Map-based planning enables predictive trajectory planning and robot control and also considers information regarding obstacles which specifically cannot be detected by one of the sensors (“blind spot” of a sensor). In particular, information can be considered which cannot be detected with sensors such as, for example, virtual obstacles indicated in the map (e.g. blocked-off areas) that the robot is not allowed to travel into, traverse, and/or process autonomously. With the exemplary embodiments described herein, the criteria, for example, which are used to switch from one contour-following mode into another contour-following mode (or to terminate a contour-following mode) can be evaluated based on the map. For example, a criterion for terminating a contour-following mode may be that the robot can rotate in the direction of a target point without collision. This criterion, which is known as “Robot can rotate to the target point without collision,” can be evaluated, for example, by means of the current map data of the robot.

For navigation and map creation, sensors with a comparatively large range are typically used to detect obstacles, said sensors being capable of detecting obstacles farther away very well but frequently being unsuitable at close range. For example, a triangulation sensor can be used which can determine the distance away from said obstacle H by emitting structured light (e.g. a laser beam or split laser beam) and detecting the light scattered back by an obstacle H. Normally, the measurement of the distance away from the obstacle becomes more precise as the distance decreases. However, a minimum distance is also possible, in which the backscattered light can no longer be received by a sensor because it is outside of its field-of-view. For example, sensors can be used which measure the travel-time measurement of an emitted signal (light, sound); these sensors normally also have a minimum distance for detecting an obstacle. With cameras, there may also be problems at close range due to a limited field-of-view as well as limited focusing.

Despite the limited sensor system, the robot can navigate close to obstacles without an additional sensor being required for the contour-following run by using map data. In addition, a control opposite the preferred direction of travel (i.e. in the backward direction) is easily made possible without complex additional sensors being used in the rearward part of the robot.

Handling dead-end situations—backward travel: As shown by example in FIG. 3, general, non-round robot shapes may mean that a movement of the robot 100 in a preferred direction (forward direction) is not always possible, because a rotational movement (particularly in place about the central point “×”) of the robot in the desired direction may be blocked due to an obstacle in the environment of the robot. In this case, the robot is in a dead-end situation. It should be noted that particularly robots for processing a surface area in such situations should move in order to achieve the best-possible surface-area coverage of processing and efficient cleaning of corners and edges. This means that the robot is inevitably placed in dead-end situations repeatedly in normal operation when performing its tasks.

A simple option for navigating out of a dead-end situation is for the robot to move backward, precisely on the path on which the robot moved (forward) into the dead end. This means that the most recently created control commands for the drive unit would be executed again in the reverse order and in inverted form until a terminate condition is fulfilled (e.g. the robot can rotate in place).

To implement the previously mentioned reverse run in order to navigate out of a dead-and situation, additional information regarding the control commands and/or the path traveled (e.g. waypoints) of the robot must be stored, whereby the memory needs increase. Furthermore, an inverted control signal does not necessarily lead to an inverted movement. For example, ongoing errors of movement (for example caused by slip and drift of the drive unit and particularly the wheels) which do not have to be directly proportional to the theoretical undisturbed movement mean that an inverse actuation of the drive for the reverse run does not lead to the same trajectory as was previously traveled in the forward direction. Furthermore, there may be situations in which a mobile obstacle that has caused the dead-and situation changes its position. In this and other situations, a fixed, predefined driving maneuver (backward travel for a particular distance) does not always lead to “appropriate” behavior of the robot.

In order to overcome this problem, new control commands are created based on the map information in order to control the robot in the backward direction. In this case, particularly the contour the robot followed to get into the dead-and situation can be followed. This continues until it is determined that the dead end can be exited and/or has been exited.

FIG. 4 shows a potential process for controlling an autonomous mobile robot 100 in order to follow the contour of an obstacle. In this case, a first contour-following mode is started and implemented (FIG. 4, step 10). For example, this is the direction along which the contour should be followed and which characterizes the contour-following distance d by means of the particular side of the robot facing the contour. While the robot is moving along the contour, it is possible that the robot determines that a continued movement of the robot in the first contour-following mode along the first selected direction of the contour is not possible, because it is in a dead-end situation for example (FIG. 4, step 11). The robot detects the dead-end situation, for example, in that it determines its movement options by means of its current position in the map and the obstacles shown therein. If no forward or rotational movement is possible, because this would lead to a collision with an obstacle, this is then said dead-end situation. In order to navigate out of the dead end, the robot travels opposite the first direction in a second contour-following mode of the contour (FIG. 4, step 13). In doing so, a criterion is specified (FIG. 4, step 12), upon the fulfillment thereof the second contour-following mode should be stopped in order to resume, for example, the movement in the first contour-following mode along the first selected direction.

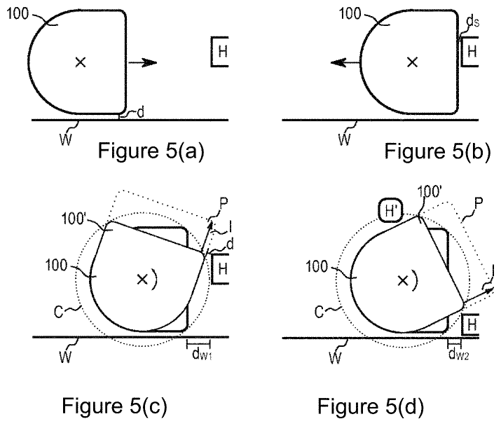

Diagrams (a) to (d) in FIG. 5 are intended to show the method according to FIG. 4 in an example. Diagram (a) from FIG. 5 shows a robot 100 as it follows the contour of a wall W (or of another obstacle), wherein the robot maintains, to the extent possible, a constant distance d away from the contour of the wall W (contour-following distance). The robot 100 continues to follow the contour until its path is blocked by an obstacle H (e.g. in front of the robot 100), as is shown, for example, in diagram (b) of FIG. 5. The obstacle H in this case may be a part of a wall, as is the case, for example, in a corner of a room. The contour is indicated as W in the following for the sake of simplicity. It is obvious that this contour W may represent a wall or also one or several other obstacles. For example, the contour W can be envisioned, however, as a wall of a room.

The path is considered to be blocked when the obstacle H is (only) a particular clearance dₛ away from the obstacle H, and a rotation of the robot 100 is no longer possible. It is understood that the rotational degree of freedom of the robot is not limited by an obstacle located in front of the robot when the safety distance dₛ is selected to be sufficiently large; however, particularly with robots for processing floors, the safety distance dₛ is selected to be as small as possible (significantly smaller than the outer dimensions of the robot itself) in order to achieve the best possible surface-area coverage when processing the surface area. Thus, the safety distance dₛ may be selected, for example, such that the robot can rotate safely without collision or that it cannot rotate without collision. In many applications, the latter is the case. The safety distance dₛ may be, for example, less than or equal to the contour-following distance d (dₛ≤d). For example, the safety distance dₛ can be dispensed with entirely (i.e. dₛ=0 mm) such that the robot would follow the contour W until it makes contact with an obstacle H in front of the robot. The contact can be detected, for example, by means of a tactile sensor (sensor that responds to touch).

In order to move out of this position, the robot controller 150 switches into a second contour-following mode, in which the robot 100 follows the contour of the wall W in the opposite direction (see diagram (b) from FIG. 5) until a defined criterion is fulfilled, namely until the robot 100, for example, is far enough away from the obstacle that it can rotate without collision and can follow the contour of the new obstacle H in the original direction (forward). The second contour-following mode thus differs from the first contour-following mode in one parameter, namely there is differentiation in the direction in which the robot should follow the contour. In addition, a criterion is set (e.g. rotation no longer blocked), in which the second contour-following mode can be terminated in order to return, for example, to the first contour-following mode or to restart it. Further contour-following modes can differ in other parameters (e.g. the contour-following distance, side of the robot (left or right) which has the contour, etc.). In simple examples, a certain contour-following mode is defined by the parameters of direction of travel (forward or backward) and the contour-following distance.

According to the examples described herein, the criterion for terminating the second contour-following mode may be that the robot can again move more or less freely and particularly can continue the first contour-following run along the contour of a new obstacle. This means, inter alia, that the robot's rotational degree of freedom is no longer blocked. However, it is a priori unclear in this case how far the robot must rotate in order to continue the contour-following run. An example of this is shown in diagrams (c) and (d) of FIG. 5.

Diagram (c) of FIG. 5 shows a driving maneuver in which the robot 100 moves passed an obstacle H which is positioned centrally in the path of the robot during the contour-following run. In this case, the robot must follow the contour of the wall W some distance d_{w1} backward until the robot 100 can again rotate freely. The space the robot needs for a rotation about the central point “×” is indicated by the circle C. It should be noted here that the robot 100 can rotate as soon as it has moved a small distance backward along the contour W. In this case, however, it cannot rotate far enough to move passed the obstacle H.

Diagram (d) from FIG. 5 shows a driving maneuver for moving passed an obstacle H which is close to the contour W to be followed. To this end, the robot must follow the contour of the wall W backward along a distance d_{w2} in order to rotate again. The distance d_{w2} to be traveled here is less than distance d_{w1} from FIG. 5 C. At the same time, the rotational degree of freedom of the robot is further limited by a second obstacle H′ which is within circle C. However, despite this limitation, the robot can move between the two obstacles H, H′ and subsequently continue the first contour-following mode.

The examples shown in diagrams (c) and (d) from FIG. 5 clearly illustrate the fact that whether and how far the robot can rotate is not a meaningful criterion for terminating the second contour-following run. The particularly applies if the first contour-following run is to be continued.

One possible criterion for the evaluation (by the robot) as to whether the second contour-following mode can be terminated and the previous contour-following run (in the first contour-following mode) can appropriately be continued is, for example, that the root can move forward in a straight line after a successful rotation (i.e. into the direction of travel of the first contour-following mode). This is indicated in FIG. 5, diagrams (c) and (d), by the passage P, in which the robot can travel the length l in a straight line. The length l in this case can be a preset value or can be defined, at least partially, based on the angle traveled during the rotation or distance d_{w1} and/or d_{w2} traveled during the second contour-following run. For example, the length l can be selected such that the front contour of the robot 100 exits the circle C. The length l may also be selected to be shorter than what is necessary to exit the circle C. This means that the robot can navigate closer to obstacles. However, this can mean that, after the return to the first contour-following mode, it must be again cancelled, which can lead to a sequence of back-and-forth movements. The criterion as to whether the second contour-following mode should be canceled can be evaluated particularly based on the map. In doing so, it is assumed that the map is sufficiently precise and up-to-date, at least in the local environment of the robot 100.

In some exemplary embodiments, the criterion for terminating the second contour-following mode is merely the possibility of a straight, forward movement. For example, the criterion may be that the robot must be able to travel forward the distance that is traveled backward in the second contour-following mode, plus a further definable distance (e.g. distance d) in a definable direction. To be able to align itself in this definable direction, the robot normally has to rotate. The possibility of rotation does not have to be an explicit component of the criterion for terminating the second contour-following mode. In some situations, the robot can reach a corresponding direction without an additional rotation when the robot moves along a curved contour (backward), for example, during the second contour-following mode. A further example in which a rotation may not be necessary is a dynamic change in the environment. For example, a user may remove the obstacle H that triggered the second contour-following mode. Consequently, the forward movement of the robot is no longer limited, and the second contour-following mode can be terminated with a straight movement without rotation.

Additionally or alternatively, when evaluating the criterion leading to termination of the second contour-following mode, the position of the obstacle H which led to a cancellation in the first contour-following mode or the position of a different obstacle H′ can be checked after a possible rotation. Thus, there should be no obstacle a definable distance away in front of the robot. At the same time, any obstacle which previously led to the dead-end situation should be positioned relative to the robot after the rotation such that it can follow the contour of said obstacle H at the defined contour-following distance d in the first contour-following mode. In particular, this means that, after a movement forward by length l, a part of the contour of the obstacle is at the contour-following distance d away from the robot (cf. diagram (c) from FIG. 5).

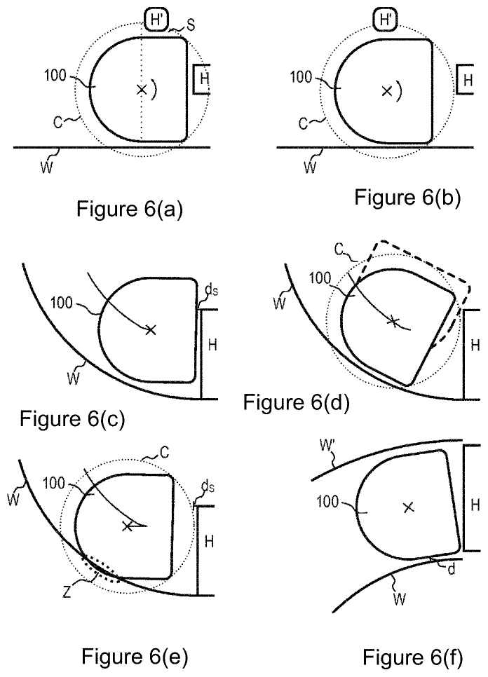

As previously explained using diagram (d) from FIG. 5, the angle about which the robot must be able to rotate at a minimum in order to terminate the second contour-following mode must be comparatively small, e.g. in a range of from 1 to 5 degrees, or a rotation can be dispensed with altogether. FIG. 6, diagram (a), shows an example in which a second obstacle H′ directly limits the rotation of the robot, in addition to obstacle H in front of the robot. Such obstacles are detectable, for example, in that they are located, at least partially, within the front sector S of the circle C (e.g. within the front semicircle). In such a configuration, a comparatively large rotation is always needed so that the robot can terminate the second contour-following mode and continue the first contour-following mode. For example, in order to limit the movement options to be checked, it may be advantageous here to set a large minimum angle, which must be between the orientation of the robot before and after the rotation, as the criterion. This minimum angle may be selected as a standard value (e.g. 45°) or dependent on the robot shape and/or shape and size of the obstacle H′.

The setting of the criterion for terminating the second contour-following mode can thus be dependent on the position (e.g. is stored in a map of the robot) of the obstacles in the environment of the robot. In particular, a first criterion can be defined and used when at least one point of an obstacle is within a definable sector S particularly close to the robot, and otherwise a second criterion. According to both criteria, a rotation of the robot, for example, into a position away from the contour should be possible, wherein, at least with the first criterion, the angle of rotation may be greater than a definable minimum angle. If both criteria contain a minimum angle, the minimum angle according to the first criterion is greater than the minimum angle according to the second criterion.

FIG. 6, diagram (b), shows an example in which the second obstacle H′ is situated in the same position as in FIG. 5, diagram (d). According to the example shown in FIG. 5, diagram (d), the first obstacle H is close to the contour W such that the robot can move between the two obstacles H, H′ after a small rotation. In FIG. 6, diagram (b), the first obstacle H is positioned such that this type of driving maneuver is not possible, because the two obstacles H, H′ are too close to one another. Thus, as in the example shown in diagram (a) of FIG. 6, a criterion for terminating the second contour-following mode with a large minimum angle can likewise be defined and used.

The decision as to whether such a minimum angle is necessary can be determined, for example, based on the position, shape, and size of the first obstacle H. Alternatively, the specifying of a minimum angle can be dispensed with (as in the example shown in diagram (d) of FIG. 5). The minimum angle can be set subsequently, for example, when it is determined in the second contour-following mode that an obstacle H′ is in the sector S and thus blocking a rotation of the robot. Alternatively or additionally, the large minimum angle can be specified subsequently when it is determined in the second contour-following mode that the obstacle H is no longer blocking the rotation of the robot due to the distance away from the robot; however, due to obstacle H′, the criterion for terminating the second contour-following mode cannot be fulfilled. The criterion can thus be updated in the second contour-following mode during a run.

In addition to the evaluation of a potential movement based on the information regarding the robot environment (particularly the map data), the criterion for terminating the second contour-following mode may additionally comprise the collision-free implementation of said planned movement. This means that the second contour-following mode would not terminate until successful implementation of the movement. If an unexpected collision occurs during the movement, the second contour-following mode would directly continue control of the robot 100 along the contour of the wall W (in the backward direction). The information on the collision would be included in the information regarding the robot environment and particularly in the map data and would thus be available for controlling the robot subsequently. It should be noted that the part of the movement implemented up to the point of collision normally can be undone in the second contour-following mode even though this is not explicitly implemented. Instead, it is a property of the counter-following mode which guides the robot 100 into an extensively parallel alignment with the contour to be followed.

In the examples shown in FIGS. 5 and 6, diagrams (a) and (b), it should be noted that the contour W is always represented as being straight and thus the robot is reset in a straight line. In general, the contour of the wall W (or of another obstacle) is not necessarily straight but instead may contain curves and corners that the robot would likewise have to travel back over in the second contour-following mode. The example in diagrams (c) and (d) of FIG. 6 illustrates the case with an uneven contour W, which the robot follows in a first contour-following mode, until an obstacle H blocks further execution of the contour-following run (see diagram (c) from FIG. 6). In the second contour-following mode following this, the robot travels back along the contour W until it can rotate to the extent that it can move passed the obstacle H (criterion for terminating the second contour-following mode). Subsequently, the first contour-following mode can be continued, and the robot follows the contour of the obstacle H. This approach differs from the process in other approaches shown here, in which a predefined movement pattern (maneuver) is used such as, for example, a simple, straight backward run. This case is shown in diagram (e) of FIG. 6; a collision occurs in the sector marked with Z due to simple resetting. Diagram (f) from FIG. 6 illustrates a further example of a dead-end situation, in which it is not possible to exit the dead-end without collision by means of a simple, predefined movement pattern such as, e.g., resetting and rotation. In addition, the robot can react directly to dynamic changes caused by movements (e.g. of a person or animal) in its environment (which it detects, for example, with the sensor unit 120 and uses to update its map data). This makes the process shown significantly more flexible and usable in a more versatile manner.

While the robot follows the contour of the wall W (or another obstacle) in the second contour-following mode, it is possible that the second contour-following mode likewise does not enable any further movement. For example, this is possible when an obstacle is positioned on three sides of the robot, i.e. particularly the wall W, the contour of which is being followed, an obstacle preventing further backward movement, as well as obstacle H′, such that the criterion necessary for terminating the second contour-following mode is not fulfilled. In this case, the direction can be changed again such that the robot moves back to the original direction in a third contour-following mode. In order to extensively prevent repetition of the same previous driving pattern which led to the dead end, the side on which the robot is following the contour, for example, can be changed. The robot hereby frees itself from the contour W in order to follow, for example, the contour of obstacle H′ (which is blocking fulfillment of the criterion necessary for terminating the second contour-following mode), and reach a position which enables, for example, a continuation of the first contour-following mode. A new criterion can be set for terminating the third contour-following mode. Alternatively, the previously set criterion for terminating the second contour-following mode may be retained and/or adopted.

The process in this case substantially corresponds to the process described in FIG. 4, with the sole difference that a further contour-following mode preceded the first counter-following mode 10. In principle, this process can be repeated with a fourth, fifth, etc. contour-following mode until the robot has found a way out of the dead-end situation. In general, the contour-following modes differ through one of the following features at a minimum:
the direction in which a contour is being followed;
the side of the robot facing the contour;
a change in the parameters for navigation such as, e.g., the contour-following distance d, the safety distance dₛ to obstacles, speed;
the priority with which contact with obstacles (collisions) is prevented;
the robot shape considered for determining collisions (e.g., a safety distance may be considered in the form of a virtually enlarged housing shape of the robot for map-based evaluations);
the rules for generating movements along the contour; and
the interpretation and evaluation of map data.

By changing the contour-following distance d and/or the safety distance dₛ (decreasing or increasing), the robot can have more clearance for movement. In a similar manner, the accuracy of navigation can be increased by adapting the speed of the robot, whereby the robot, for example, can navigate more easily through narrow points or can better respond to driving errors, for example, caused by the floor covering (e.g. friction and drift).

The robot shape to be noted must be reflected correspondingly when the direction of travel changes. For example, the rotational degree of freedom with a D-shaped robot may be limited during the contour-following run (depending, inter alia, on the contour-following distance d). If the flat side is pointing in the direction of travel in this case, a rotation toward the contour is no longer possible or only to a limited extent. On the other hand, if the flat side is pointing opposite the direction of travel, a rotation (in place) away from the contour is limited. This directly means that the rules for creating the movement along the contour are also changed accordingly.

In some exemplary embodiments, it is possible that the robot 100 cannot find a way out of the dead end with a strategy avoiding collision. This can be detected, for example, when the robot unsuccessfully changes the contour-following mode multiple times (particularly in the direction of and/or on the side of the robot facing a contour), without it being possible to fulfill the criterion for terminating the respective contour-following mode. The cause of this may be, for example, faulty sensor and/or map data, whereby the robot sees a point in the real environment as being blocked by an obstacle, but it is actually free for movement. In such a case, the collision-avoiding strategy can be abandoned and replaced by a strategy moving toward contact.

The points at which the robot makes contact with an obstacle in this case can likewise be stored in the map data and used for further control the robot. In one exemplary implementation of the method for controlling the robot in a contour-following mode, the first contour-following mode and the second contour-following mode (as well as further contour-following modes) may each be independent software modules. Alternatively or additionally, several contour-following modes may be implemented in one software module, which can be started with differently set parameters.

It should be noted that the robot may also find itself in a dead-end situation without having previously implemented a contour-following run. In this case, it is also useful to follow a contour backward until the robot determines that it can move out or has moved out of the dead end. For example, for planning the function of the robot, a prioritized control instance can start a first contour-following mode which should guide the robot in the preferred direction (forward direction) along the contour. Before the robot executes a movement, it is possible it determines that no movement can be executed in this first contour-following mode, which is why a second contour-following mode is started in the opposite direction and a criterion for terminating same is defined and used. Alternatively or additionally, the prioritized control instance for planning the function of the robot can directly start the second contour-following mode and terminate it again according to definable criteria.

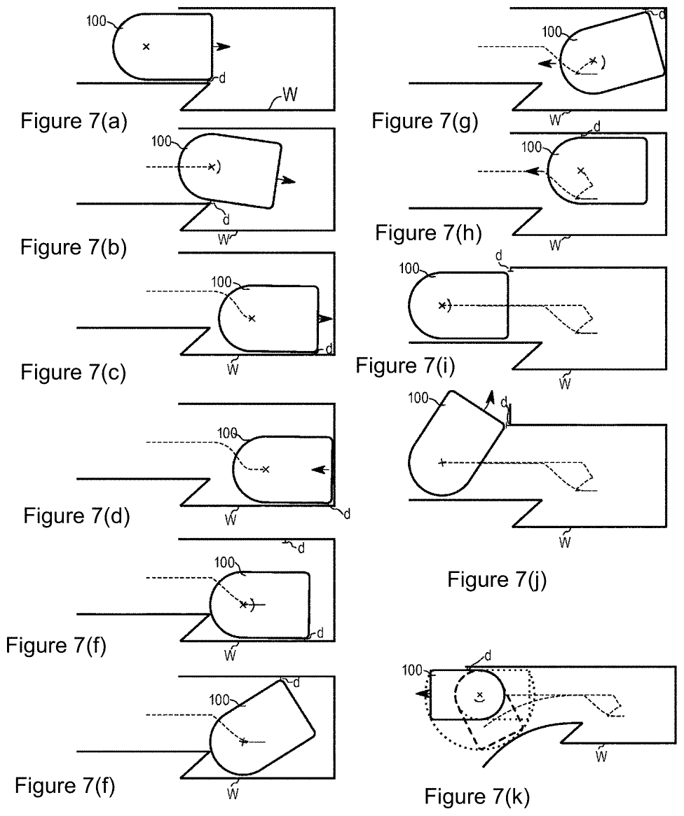

FIG. 7 illustrates, using a further, somewhat more complex example, the method for controlling the autonomous mobile robot in a dead-end situation that is geometrically somewhat more complicated than in the previous examples. This example also makes it clear that simple approaches such as, for example, the implementing of a fixed, predefined movement pattern, are not always suitable for solving a dead-end situation. Diagrams (a) to (d) in FIG. 7 show the robot 100 in sequential positions while it moves along the contour W in a first contour-following mode, wherein the contour W is to the right of the robot (i.e. the right side of the robot 100 is facing the contour W). In the present example, the contour W has a bend, and the robot follows the contour over the bend and continues (cf. diagrams (b) and (c) in FIG. 7). In the situation shown in FIG. 7, diagram (d), the robot 100 has reached a position in which further movement is no longer possible in the first contour-following mode. Consequently, the controller 150 of the robot 100 switches into the second contour-following mode, in which the direction of travel is backward. The robot follows the contour W back and reaches another dead-end situation at the aforementioned bend in the contour W (see diagram (e) in FIG. 7); both the continuation of a reverse run and a larger rotation (e.g. of 45°) are blocked.

As a response to this second dead-end situation, the second contour-following mode is also terminated and the controller 150 of the robot 100 switches into a third contour-following mode, in which both the direction of travel and the side of the robot on which the contour is located (which should be followed at distance d) is inverted as compared to the second contour-following mode (forward movement instead of backward movement, contour to the left instead of to the right). The response of the robot is shown in diagrams (f) to (g) in FIG. 7; the robot 100 rotates to the contour on its left, and aligns itself to said contour at a contour-following distance d, until the forward movement is again blocked (diagram (g) from FIG. 7). As a response to this third dead-end situation, the third contour-following mode is terminated and the controller 150 of the robot 100 switches into a fourth contour-following mode, wherein again the direction of travel is changed (reverse movement, contour on the left is retained). In this case, the robot can quickly align itself parallel to the contour on its left at the contour-following distance d. Starting from the situation shown in diagram (h) from FIG. 7, the robot can follow the contour on its left in reverse (in the fourth contour-following mode) until the criterion for terminating the contour-following mode is fulfilled, which is the case in the situation shown in diagram (i) from FIG. 7. The robots can rotate at a (pre-definable) angle and can follow a further contour (contour extending vertically in diagram (j) of FIG. 7) in the first contour-following mode (forward movement, contour to the right of the robot). The dashed line shows the traveled path of the central point “×”.

Diagram (k) from FIG. 7 shows a situation modified slightly as compared to diagrams (a) to (j), which the robot reaches in a manner similar to that shown in diagrams (a) to (j). In the example shown, the robot can rotate clockwise after the reverse run (in the fourth contour-following mode) (such that the contour is again to the right of the robot), and the contour-following run continues in the first contour-following mode.

Basic movements: In the following, a possible form of the control of an autonomous mobile robot 100 is shown in a contour-following run. In order to reduce the complexity of the numerous possibilities for moving the robot 100, at least three basic movements are introduced which are suitable for moving the robot into a desired direction along a contour at a definable contour-following distance. These basic movements are evaluated based on the information regarding the robot environment and particularly based on the map data. The basic movement with the best evaluation is selected. Control commands for the drive unit 170 are created based on the selected basic movement. This method uses the advantages of planned movements and simultaneously enables a quick response to changes in the environment (e.g. movement of people or animals) or driving errors, for example due to the floor covering (friction, drift), in that there is only a short planning horizon and fast repetitions of planning.

In evaluating the basic movements, it can be determined that none of the basic movements can be or should be executed. For example, it can be determined based on the map data that none of the basic movements can be executed without collision. Based on further selection rules, it can be determined that none of the basic movements can be suitably executed. An example of this is a dead-end situation described more precisely in the following in which the first contour-following mode does not enable any further movement in the preferred direction along the contour.

In order to guide the robot out of a dead-end situation, a new contour-following mode is started, wherein principally the same or similar basic movements can be used, but the direction of the movement is inverted. The rules for evaluating the basic movements can be redefined or retained extensively unchanged. If the rules for evaluating the basic movement remain unchanged, it must only be noted that the contour of the housing of the robot moving backward is used (with the D-shaped robot for example, the semicircular side is thus in the direction of travel).

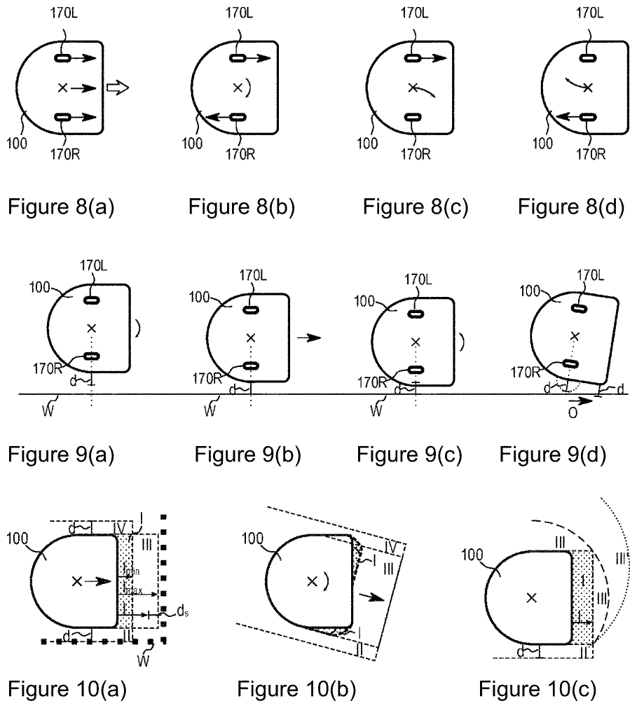

FIG. 8 shows potential basic movements. They comprise the following at a minimum:
a first basic movement, which is a straight movement in the current direction of travel;
a second basic movement, which is a rotation toward a contour to be followed;
a third basic movement, which is a rotation away from a contour to be followed;

The direction of rotation of the third basic movement is thus opposite the direction of rotation of the second basic movement. Which side of the robot 100 should be facing the contour to be followed can be defined by a prioritized planning instance, by means of which the contour-following run is triggered. Alternatively or additionally, the side of the robot having a contour which can or should be followed can be determined at the start of the contour-following mode (for example based on map information). If the robot should follow a wall, the side that the robot should turn toward (contour) should normally be obvious. If the robot is supposed to avoid an obstacle, the robot can theoretically move clockwise or counterclockwise around the obstacle, wherein a preferred direction (e.g. clockwise) can be predefined, which is only deviated from by exception.

FIG. 8, diagram (a), shows a movement straight ahead as a first basic movement. In this case, both wheels 170L, 170 R move forward by the same distance. The distance traveled during the first basic movement may be a fixed distance. For increased flexibility, the distance to be traveled can be determined during the evaluation of movements. In this case, a minimum and/or maximum distance, for example, for the straight movement can be considered.

FIG. 8, diagram (b), shows a possible variant of the second and/or third basic movement. In this case, wheel 170R and wheel 170L move in the opposite direction, which means that the robot rotates about its central point.

FIG. 8, diagram (c), shows a further possible variant of the second and/or third basic movement. In this case, only one of the two wheels 170L moves forward, while the second wheel 170R remains still. Thus, the entire robot rotates around the second wheel 170R. The central point “×” moves forward in a circle.

FIG. 8, diagram (d), shows a further possible variant of the second and/or third basic movement. In this case, only one of the two wheels 170R moves backward, while the second wheel 170L remains still. Thus, the entire robot rotates around the second wheel 170L. The central point “×” moves backward in a circle. However, the direction of rotation is the same as in FIG. 8, diagrams (b) and (c).

Through suitable actuation of the drive wheels, the robot can also be rotated about other points, wherein the central point “×” always moves in a circle. By selecting a suitable rotational movement, particularly the desired properties of the movement of the work unit 160 (not shown) can be achieved. For example, it may be desirable in a normal case that the work unit 160 of the robot 100 always moves forward, which can be achieved, for example, by means of a movement shown in diagram (c) of FIG. 8. In some applications, for example on carpet, on which, for example, a brush of the robot would leave a significant cleaning track, a better cleaning pattern could be achieved. A cleaning unit arranged in the front area of the robot (cf. FIG. 3, diagram (b)) would be moved backward a bit by means of the movement shown in diagram (d) of FIG. 8, whereby more thorough cleaning can be achieved. A rotation opposite the rotational movements shown in diagrams (b) to (d) of FIG. 8 (for the corresponding definition of the second and/or third basic movement) can be created by swapping out the drive rule (forward/reverse) for the two wheels 170L, 170R.

The angle of rotation to be traveled during the second and/or third basic movement may be a fixed angle, for example, of from 0.5° to 5°. For more flexibility, particularly for aligning the robot parallel to the contour to be followed, a suitable angle of rotation can be determined during the evaluation of movements. In this case, a minimum and/or maximum angle of rotation, for example, for the movement can be considered. The rotational movement used during the second and the third basic movement may be substantially the same, wherein only the direction of rotation differs. For example, the rotation in place shown in FIG. 8, diagram (b), can be used for both basic movements.

Alternatively, the second and third basic movements may be selected to be different (i.e., not only is the direction of rotation different but also another feature of the movement). The characteristics of the movement can hereby be more easily adapted to the different requirements. Thus, the second basic movement may include a small movement backward according to FIG. 8, diagram (d), in order to bypass small obstacles such as chair legs (and thus have more thorough cleaning), and/or the third basic movement may include a small movement forward according to FIG. 8, diagram (c), in order to achieve smooth movement for the alignment parallel to a wall. The resulting movement of the robot is a sequence of individual basic movements (e.g. multiple rotations 1° to the right, forward movement, multiple rotations 1° to the right, forward movement, etc.) which would lead to a jerky movement if they are executed sequentially. To this end, the control unit 150 may be designed to smooth out this movement (e.g. with a moving-average filter).

Further basic movements may also be considered. For example, basic movements against the current direction of travel (backward) can also be considered. In order to achieve a smooth movement, the control commands, which are to be created for the planned basic movements, for implementing the basic movements may be additionally smoothed.

Evaluating the movements: Various methods are known for evaluating movements for controlling an autonomous mobile robot 100. For example, “virtual forces,” “virtual potentials,” or “virtual costs” can be determined based on obstacles detected in the environment of the robot. They can be used to evaluate the basic movement, wherein the movement following a definable optimum is selected (e.g. movement along the virtual force, minimizing of virtual potentials or virtual costs). The selection of the method for evaluating the movement is not essential for executing the exemplary embodiments described herein.

During the evaluation of the basic movements, it is possible for two or more basic movements to be evaluated equally. In this case, the basic movement which is guided along the contour is preferred. For the movements shown herein, this means that a rotation toward the contour (second basic movement) is preferably executed in the event of an equal evaluation. With an evaluation of the straight movement (first basic movement) and the rotation away from the contour (third basic movement), the straight movement along the contour is selected (first basic movement).

One or more previous basic movements can be considered in the evaluation of the basic movements. Thus, for example, it may be “forbidden” to undo the last movement. Particularly when the second and the third basic movement (rotation toward the contour and away from the contour) is a rotation in place (cf. diagram (b) in FIG. 8), a direct sequence of these basic movements can be excluded. Further rules regarding the sequence of the basic movements can be set up in order to achieve smoother movement behavior of the robot along the contour to be followed.

An essential aspect when evaluating the movement is the avoidance of collisions. For example, a movement that would lead to a collision with at least one point of an obstacle is generally excluded or assigned very high costs. In addition, it may be suitable to consider the position of the contour of the obstacle to be followed during the evaluation of the movement. FIG. 8 shows four simplified examples in diagrams (a) to (d). If the distance between the contour W to be followed and the autonomous mobile robot 100 is greater than a definable distance d (contour-following distance) as in diagram (a) of FIG. 9, the robot should rotate toward the contour (second basic movement). As shown in diagram (b) of FIG. 9, if the distance between the contour W to be followed and the autonomous mobile robot 100 is approximately equal to the definable contour-following distance d (e.g. within a certain tolerance range d±ε), the robot substantially moves straight ahead parallel to the wall (first basic movement). If the distance d between the contour W to be followed and the autonomous mobile robot 100 is less than the definable contour-following distance d as in diagram (c) of FIG. 9, the robot should rotate away from the contour (third basic movement).

As shown in diagram (d) of FIG. 9, the robot 100 is generally not aligned parallel to the contour W. Accordingly, a control (i.e. an automated selection of a sequence of basic movements) of the robot 100 must occur such that the robot 100 is aligned essentially parallel to the contour W. To this end, for example, the orientation O of the contour W can be determined and the basic movement can be selected based on the orientation O of the contour and the orientation of the robot, such that parallel alignment takes place at the definable contour-following distance d (orientation of the robot 100 and the contour W are then the same). At this juncture, it should again be noted that the contour W is generally not in a straight line even if it is shown as a straight line in simplified form in the figures.

The orientation O of the contour W can be determined, for example, as a connection vector of two points of the contour, as a regression line of a selection at several points, as a tangent to the contour, or the like. Mapping of the environment can take place, for example, by means of an algorithm for feature extraction, in which parts of the contour of an obstacle (particularly of a wall) are detected and stored as a line (or surface). The orientation O of the contour normally has a natural direction which results, for example, from the direction from which the obstacle was observed and/or from the direction which the robot should follow along the contour. If the contour is represented as an unaligned object (e.g. line), the alignment of the robot parallel to the contour is still clearly defined by the selection of the side of the robot which the robot should be facing during the contour-following run of the contour W (and thus also by defining the direction of rotation of the second basic movement).

The environment of the robot can be divided into individual sectors for evaluating a basic movement. One potential division comprises, for example, one sector in which there is no obstacle for collision-free execution of the basic movement, one sector for analyzing the contour to be followed, and/or one sector for analyzing further movement options. The subdivision of the environment of the robot into sectors is shown by example in diagrams (a) to (c) of FIG. 10.

Diagram (a) of FIG. 10 shows an example of the sectors in the environment of the robot for evaluating a straight movement (first basic movement). A wall W with a corner is shown by way of example as the contour to be followed.

Sector I (shown shaded in diagram (a)) describes the surface that the robot needs for straight (forward) movement by the minimum length lₘᵢₙ. If at least one part or one point of an obstacle is in this sector, the movement cannot be executed without collision and would thus be excluded.

Sector II is an area next to the robot on the side of the contour to be followed. Starting from the robot side, this sector, for example, is as wide as the contour-following distance d. If at least a part or a point of an obstacle is within this sector II, this is not necessarily an exclusion criterion for executing the movement. However, there can be a check, for example, during the evaluation to determine whether the robot should increase the distance away from the contour W to be followed, for example, by means of the third basic movement. For example, if the contour W protrudes significantly into sector II, the evaluation may mean, for example, that the robot moves away from the contour. However, if only a small corner or an individual point is positioned close to the edge in sector II, this should not lead to an invasive movement in order to prevent a faltering movement. To this end, for example in the case of a cost-based evaluation of the third basic movement, definable basic costs can be considered which correspond to the costs of a small corner protruding into sector II. For example, the costs may be determined based on the length and/or the surface-area portion of the part of the contour protruding into sector II. If parts of the contour to be followed are located on the edge of sector II, this may result in a bonus (e.g. negative costs). If there is no contour in sector II and particularly in the edge area of the contour to be followed, this can likewise be assigned costs.

Sector III is an area in which a further potential movement of the robot is checked. For example, there is a check to determine whether and the extent to which the robot can move further forward in a straight line without this resulting in a collision. This is limited, for example, by a maximum planning horizon 1ₘₐₓ. Within said sector III, the robot can determine, for example, a distance 1ₘᵢₙ<1<1ₘₐₓ that it can travel without collision. In this case, a safety distance dₛ away from an obstacle line in front of the robot, for example, can be considered.

Sector IV is an area next to the robot 100 on the side of the robot facing away from the contour. Normally, there is no obstacle here. If at least a part of an obstacle is located here, this information can be used to move the robot 100 through the corridor between this obstacle toward the contour W.

Diagram (b) from FIG. 9 shows an example of the sectors for executing a rotation (second/third basic movement). It should be noted that a comparatively large rotation was selected for a better representation. The rotation can be significantly smaller for the actual robot control.

Sector I shown shaded in diagram (b) of FIG. 10 is the area the robot will cover during a rotation in place (cf. diagram (b), FIG. 8). This depends greatly on the shape of the robot. This sector is not available for a round, symmetrical robot (cf. diagram (a) from FIG. 3), because there is no limitation in the rotational degree of freedom caused by close obstacles due to the symmetry. For the D-shaped robot 100 shown in diagram (b) of FIG. 10, sector I is divided into two independent parts which are determined by the two corners (on the right and left, front of robot). The rear part of the robot is designed to be round such that there is no limitation in the rotational degree of freedom in this area. When the rotation is not executed about the central point but instead about a different point (cf. diagrams (c) and (d), FIG. 8), sector I is correspondingly larger and shifted.

In addition, the option of a movement such as a straight movement after completion of the rotational movement can be included in the evaluation with sector III. In this case, obstacles can also be evaluated in sectors II and IV next to the robot. For example, it may be provided to only evaluate a rotation toward the contour W (second basic movement) as being suitable when a subsequent straight movement by a definable distance (e.g. 1ₘᵢₙ) can be executed. The angle of rotation and the distance 1ₘᵢₙ of the translational movement following the rotation may be matched to one another. For example, if the robot is further away from the contour than the contour-following distance, the robot should be able to rotate toward the contour; when the distance between the robot and the contour is less than or equal to the contour-following distance, a selection of a basic movement toward the contour should be prevented (because movement in a straight line is no longer possible after a rotation) This behavior can be achieved by matching 1ₘᵢₙ and angle of rotation to one another.

It should be noted that when a straight movement is no longer possible after a rotation, the planned basic movement (i.e. the rotation) might have to be undone, which is normally undesirable and should be avoided. This can be prevented with the mentioned condition that a straight movement at a definable distance should be possible after the rotation. This does not mean that the straight movement has to be actually executed directly following. Alternatively or additionally, the robot can also check a further additional rotation, similar to the straight movement by distance 1ₘᵢₙ in the example shown in FIG. 10, diagram (a).

In some applications of autonomous mobile robots, it is desirable that the robot has to move backward as little as possible. The frequency of backward runs can be reduced when the robot checks, for each (basic) movement, particularly each straight movement (first basic movement), whether a complete or partial rotation without collision is possible after execution of the straight-line movement through sector I. Sector III shows an example of the sector in which there is no obstacle which means that the robot can rotate about the central point. Sector III′ shows an example of the sector in which there is no obstacle which means that the robot can execute a circular movement about a point above the central point (cf. the case from diagram (c) of FIG. 8).

In addition, for example with cleaning robots, the processed surface (i.e. the surface traveled by the processing unit 160) can be stored as map information and used to evaluate the movements of the robot. Simultaneously, a gain in processing can be determined for a basic movement to be evaluated and used for the evaluation thereof. For example, in this manner, it can be detected when the robot has traveled along the contour completely and again reached a previously processed area (particularly but not exclusively the starting point of the contour-following run). A processing gain assigned to a (basic) movement may be, for example, the (not yet processed) surface area which would additionally be processed upon execution of the movement. This surface area may also be weighted (e.g., depending on the floor covering or the room in which the robot is located).

For example, the robot may maintain a greater distance to a contour it has previously already cleaned but along which it still must travel again. Furthermore, a greater contour-following distance may require less accuracy in navigation in order to prevent unintentional collisions. Thus, for example, the planning horizon and/or the speed of the robot could be increased. For example, a greater distance can be maintained away from obstacles in front of the robot, whereby the robot no longer moves so frequently and so far into corners and other tight spots (potential dead ends)

Parameter selection: The examples described herein relating to a method for controlling a robot by means of three or more different basic movements and the evaluation of these movements according to simple, definable rules is a very powerful tool with which essentially numerous movement profiles can be created in a contour-following run for different application purposes. However, the selection of the numerous parameters (evaluation rules, point of rotation of the rotational movement, distances traveled and angle of rotation) can quickly become confusing and complex. With the aid of simulations, the behavior of a robot can essentially be analyzed with a given parameter set and adapted to a desired behavior.

In addition, the use of optimization methods such as, for example, machine learning methods, enables an at least partially automated determination of the parameters. For example, certain scenarios (various arrangements of obstacles such as walls and chair legs) can be specified and optimized with definable measure functions. For example, the processed surface in the vicinity of a wall can be maximized or the time required can be minimized. Additionally or alternatively, movement patterns desired by a person can be specified (e.g. determined based on market studies). The parameters can be optimized to the extent that the robot path (simulated and/or in testing) is as close as possible to the specified movement pattern.

Nonvisible obstacles: The contour-following run can be planned and executed as described to be extensively collision-free based on the information in the environment and also based on the map data. In particular, the evaluation of basic movements or the criteria for terminating a contour-following mode can take place based on mapping. In addition, the robot may have suitable emergency routines (e.g. software module executed by the control unit 150, cf. FIG. 2) which can be started if there are unforeseen events. For example, a planned movement can be canceled and the robot 100 hereby stopped in order to prevent an accident or to limit its effects. The information regarding the unforeseen event can be included, for example, in the map data and used for further control of the robot. After completion of the emergency routine, the contour-following mode thusly canceled can be continued or the current task of the robot can be re-planned.

Such an unforeseen event is, for example, the detection of a drop-off edge such as with a stairstep which is only detected with a corresponding sensor when the robot gets close to the edge and/or has traveled it at least partially. A further example of an unforeseen event is contact with an obstacle (e.g. a collision). This can occur because the obstacle was previously not detected with the navigation sensor and/or included in the map data. This can occur with low-lying, transparent, or reflective obstacles. In some cases, a driving maneuver also may not be executed as planned, for example, due to poor flooring, whereby the robot unintentionally collides with a previously detected obstacle. It is also possible for an obstacle to move (e.g. from the influence of a person or an animal) and thereby cause a collision.

In addition to the immediate stop of the robot, a further standardized movement adapted to the unexpected event (which triggered the emergency routine) can be executed within the scope of the emergency routine. For example, the last movement can be inverted (reversed) at least to the extent that the robot maintains a safer distance away from a detected drop-off edge and/or that a tactile sensor for detecting a collision or contact with an obstacle is again reset (i.e. obstacle no longer detected). For example, the robot can move a few centimeters backward. If the unexpected event occurs during a rotation, the robot can rotate in the opposite direction.

After completion of the standardized movement, the normal contour-following run can be resumed. The cause of the unexpected event can be entered into the map so that it can be considered for the further evaluation of the movement of the robot. This might be, for example, the location at which the drop-off edge was detected. This location can be determined based on the pose (position and orientation) of the robot and the position of the sensor (in the robot) which detected the drop-off edge. In general, this is one or more points which can be handled like points of a contour of an obstacle.

An unexpected event occurring due to contact and/or collision is likewise entered into the map. In doing so, it may be desirable that the tactile sensor for detecting a collision or contact has comparatively good spatial resolution such that the position at which contact occurred with the obstacle can be entered into the map with a high degree of accuracy. In practice, tactile sensors, however, often have only a very coarse resolution. In this case, the entire portion of the outer contour of the tactile sensor of the robot, on which an obstacle may have generated the measured sensor signal, can be entered into the map (as a geometric figure or in the form of sampling points). For example, this may be a contact switch for various independent sectors of the robot. It should be noted that additional information regarding the location of the collision can be derived from the triggering of two contact switches in close chronological order, which can be entered into the map in a suitable manner.

Because the information hereby included in the map does not directly correspond to the position of obstacles, it may be necessary to handle it differently than the previously described information regarding obstacles. During the evaluation of the basic movement, this means that the type of obstacle can be considered as well as the sensor that detected the contour of the obstacle (or a part thereof). For example, the information can be interpreted optimistically. For the evaluation of a basic movement, this means that the smallest-possible obstacle can be assumed with the position causing the least interference, as has been established by the sensor information. This may lead to further contact with the obstacle, whereby the number of pieces of tactile information regarding the undetected obstacle increases. The robot can hereby move along the obstacle with a scanning movement.

As previously mentioned in reference to handling dead-end situations, it may be necessary to start a contour-following mode in which a collision is intentionally risked. This means that the information detected with the navigation sensor regarding the environment of the robot and/or the map data cannot be used or only to a limited extent. The previously described emergency routine thus contains a method as well for tactile exploration of the environment, based on which the robot can move along a contour in a contour-following mode.

In some exemplary embodiments, the robot can be designed such that the risk of a collision with a detected, moving obstacle or due to a driving maneuver not executed according to plan is detected before there is an actual collision or contact with the obstacle. Subsequently, the robot can be stopped immediately, whereby a collision can be prevented.

Virtual obstacles: Further examples of obstacles of various types which can be considered in special form during the evaluation of the basic movement are markings in the environment provided by a user with the goal of limiting the sectors of the robot's operational area that the robot is excluded from traveling. Such markings are, for example, magnetic strips and current loops which establish a magnetic field detectable by the robot or light beam emitters which emit a light beam (e.g. infrared laser beam) detectable by the robot. These markings can be detected using a corresponding sensor of the sensor unit 120 of the robot 100 (cf. FIG. 2) and are not traversed by the robot, for example. Thus, they represent a type of obstacle for the robot which can be considered during the navigation of the robot. In addition, the contour of such an obstacle can be followed in a contour-following run.

Because a collision with a (e.g. magnetic or optical) marking is not possible, they can be handled differently in the evaluation of basic movements than obstacles, for example, that have been detected by means of distance measurement or with a camera. Thus, this is sufficient for preventing traversing of the marking while a limitation of the rotational degree of freedom is not necessary. Thus, for example, it can be accepted that a corner of a D-shaped robot (cf. FIG. 3) traverses the marking during a rotation.

An advantage in using map data for the control of the robot, particularly in a contour-following mode, is the availability of virtual obstacles which mark areas in the map over which the robot cannot independently travel and/or traverse. These areas can be entered, for example, by a user via the HMI 200 or created independently by the robot (“learned”). In this manner, the robot can note areas that it will not travel, for example, because safe operation is not ensured here. A user can hereby block, for example, an area temporarily or permanently for the robot without having to provide physical markings to the environment. This is significantly more flexible and less disruptive than real markings.

The same thing applies to such purely virtual obstacles as for obstacles created by markings. Because a real collision is not possible, simplified handling is sufficient. It can be designed solely to prevent traversing of the virtual boundary of the virtual obstacle and particularly the traveling into the blocked area. This method is explained for virtual obstacles by means of example.

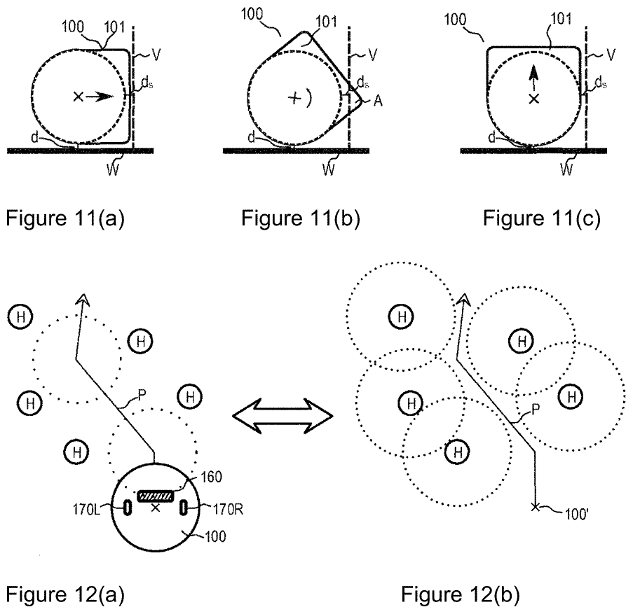

FIG. 10 shows an example of the contour-following run along the contour W of an obstacle (e.g. a wall) and a contour V of a virtual obstacle perpendicular thereto, which is not contained in the map but that actually exists. The complete D-shape of the robot is noted for the evaluation of the basic movements along the contour W of the wall. In contrast, only a simplified virtual shape 101 of the robot 100 is considered for the evaluation of the basic movements with respect to the contour V of the virtual obstacle. In the example shown from FIG. 11, the simplified virtual shape 101 is a circle, the center of which is central point “×” and the diameter of which corresponds to the width of the robot. In this manner, a pure rotation in place is not limited by virtual obstacles, while a traversing of the contour V of the virtual obstacle is prevented (i.e. a virtual collision of the simplified virtual shape 101 with the virtual obstacle), in that the normal rules for preventing collisions are applied to the simplified virtual shape of the robot. The radius of the circle can accordingly be selected such that at least two points of the outer contour of the housing of the robot 100 move in the circle upon a rotation of the robot 100 about its (kinematic) center “×”. In the examples shown, the radius of the circle is equal to half the width of the housing of the robot 100. A part of the robot 100 is thus outside of the circle which represents the virtual shape 101.

In the example shown in diagram (a) from FIG. 11, the robot 100 moves along the contour W of the wall until it has reached a position in which the robot 100 is only a safety distance dₛ away from the virtual obstacle. The safety distance dₛ may be the same distance as for the other types of obstacles (cf. FIG. 5). Alternatively, it may be larger or smaller. In particular, the safety distance away from virtual obstacles in front of the simplified shape 101 of the robot 100 may be equal to the contour-following distance.

Due to the fact that only a simplified shape 101 of the robot 100 is considered during the handling of virtual obstacles, the corner formed by contours W and V will not lead to a dead-end situation; the robot can rotate away from contour W of the wall without limitation (e.g. as a rotation in place by means of a sequence of the third basic movement), whereby it is possible for the robot 100 to align itself parallel to contour V of the virtual obstacle. As shown in diagram (b) of FIG. 11, a corner A of the robot protrudes into the virtual obstacle during the rotation (third basic movement). In contrast with the example from FIG. 5, it is not necessary to exit the current contour-following mode in order to follow contour W in the opposite direction.

In the example in diagram (c) of FIG. 11, the robot is aligned completely parallel to contour V of the virtual obstacle, wherein contour V is a distance dₛ away from the robot. If the safety distance dₛ is equal to the contour-following distance d, the robot can then further follow contour V of the virtual obstacle. If the safety distance dₛ is less than or greater than the contour-following distance d, the control unit 150 will control the robot in the contour-following mode such that the distance between virtual contour V and the robot 100 (or the simplified robot shape 101) corresponds to the contour-following distance.

It should be noted that the contour-following distance and the safety distance are intended to prevent unintentional collisions, particularly in robots for processing a surface area. Because such collisions with a virtual obstacle are not possible, the contour-following distance and/or the safety distance can likewise be set depending on the type of obstacle. Especially for virtual obstacles, the contour-following distance and/or the safety distance can be set as less than that for other obstacles or even all the way to zero. Particularly a contour-following distance and/or safety distance of zero for virtual obstacles can mean less complexity for calculations and evaluations.

The biggest simplification possible of the virtual shape 101 of the robot 100 is to represent the robot with a single point. This point is preferably the central point “×” (kinematic center, center of rotation). For example, the robot can be controlled in a contour-following mode such that the robot, which is simplified into one point (point-shaped), moves on contour V of the virtual obstacle as precisely as possible. In particular, the contour-following distance d and the safety distance dₛ can be set to zero in this case (i.e. not considered). This means that the boundary of the obstacle describes the path of the robot (and/or of the kinematic center) which is currently being excluded such that the area blocked for the robot is not traversed. This can be considered when defining the blocked area. For example, the user can enter the area which should not be traversed via the HMI 200. Based on this input, the virtual boundaries of the virtual obstacle can then be determined such that the robot can reliably follow this boundary and a contour-following mode with its central point “×”.

Within the scope of, e.g., a cost-based evaluation of basic movements for the simplified virtual shape 101 of the robot 100, any movement, for example, away from the virtual contour V can be assigned costs. A movement in the blocked area can be excluded in this case or assigned higher costs than a movement in the area that is free to traverse. This is essentially similar to an evaluation based on the contour-following distance.

For robots with a very elongated shape (cf. diagram (e) from FIG. 3), a simplification into a circular shape or down to one point may mean that parts of the robot protrude very far into the virtual obstacle (i.e. the blocked area). In this case, another virtual shape can be used in order to simplify navigation and the evaluation of movements. The virtual shape should be defined as simply as possible for this and be composed of circular curves, straight lines, or simple polygon shapes (e.g. parabola). In particular, circular curves can be selected which have the central point “×” (kinematic center) as the center.

For example, the virtual shape 101 may be selected as a convex shape (i.e. any two points can be connected by a distance within the shape). For example, the virtual shape 101 is selected such that it is completely contained in the real shape. Areas of the robot that are outside of the virtual shape can thus exceed the virtual contour of the virtual obstacle, at least temporarily, e.g. during a rotation. Thus, movements, particularly rotations, which would lead to a collision with real obstacles, are enabled relative to virtual obstacles.

For example, the virtual shape 101 can be selected such that a maximum distance is not exceeded between the points of the real shape of the robot 100 and the virtual shape 100 of the robot. Similar to the simplification down to one point, the virtual shape may be a line, wherein a point on the line is the central point “×” (kinematic center). For example, it is one of the end points of the line. The second end point could then consider the elongated shape of a robot (cf. diagram (e) from FIG. 3).

It should be noted that the concept of the simplified virtual shape 101 of a robot 100 can generally describe the complete three-dimensional shape of the robot. For example, a simplified three-dimensional shape is a cone or another rotational body. In particular, the three-dimensional problem can be attributed to the two-dimensional case described herein due to suitable projection into the plane.

Simplified path planning for non-round robots: FIG. 11 shows two equivalent representations of path planning of a robot with a substantially circular base area from a starting point to a target point. In the situation shown in diagram (a) to the left in FIG. 12, a collision-free path through a number of smaller obstacles H (e.g. chair legs) should be determined. This situation is equivalent to the situation shown in diagram (b) to the right in FIG. 12, in which a path for a point-shaped robot 100′ through a number of obstacles H is to be determined, wherein the obstacles H (in comparison to the situation shown in diagram (a)) have been enlarged about the radius of the robot 100. The problem illustrated by diagram (b) can be intuitively solved, because any point not occupied by an obstacle is a potential position of the robot.

The approach illustrated in FIG. 12 is principally also possible for general non-round shapes of a robot 100. However, the rule for enlarging an obstacle depends on the orientation of the robot. At the same time, the constraint must be observed that the movement can only be parallel to the orientation of the robot. The mathematical formulation hereby becomes very complex and difficult to calculate. The complexity increases if the three-dimensional shape of the robot and the environment must be noted, such as shown in the example from FIG. 1, diagram (b). Consequently, a simpler method is required.

The problem of path planning for robots with more complex shapes can be simplified, for example, in that known methods of path planning are used for a simplified “virtual” shape of the robot for large-scale areas, particularly areas that are extensively free. Local planning while noting the exact robot shape is used at bottlenecks. For example, the methods described herein for implementing a contour-following run can be used in order to determine, for example, a path through the area with the complex environment as shown in diagram (a) of FIG. 12.

An exemplary situation is shown in FIG. 1, in which the combination of path planning with a simplified virtual shape of the robot and local consideration of the complete shape of the robot can be used. The robot is positioned with its preferred direction of travel directly in front of a wall in both representations (see diagrams (a) and (b) in FIG. 1). Neither a movement in the preferred direction of travel (forward direction) nor a rotation in place is hereby possible. This problem is ignored with path planning using a simplified virtual shape of the robot, whereby the necessary algorithms and calculations are simplified significantly. During the attempt to travel the planned path, the robot would detect that an alignment on the planned path is not possible due to an obstacle (i.e. the wall), which is why, for example, the contour-following mode is started.

As further previously described in relation to the handling of dead-end situations, this would mean that the robot moves a distance opposite the preferred direction of travel (i.e. backward) until it can rotate freely. A prioritized control instance could then determine, for example, that the robot can then align itself along the planned path and follow it, which is why the contour-following mode is terminated. A specially predefined driving maneuver with which the robot can navigate away from the wall moving backward is not necessary. In a similar manner, complex path planning considering the complete contour of the robot is not necessary for this small maneuver. The approaches to path planning described herein are thus flexible, robust, and require less resources.

The simplified virtual shape of the robot in this case corresponds particularly to a round shape with the center lying in central point “×” (kinematic center). For example, the approaches to path planning sketched in FIG. 12 can hereby be used. The result of path planning is a path P which can be implemented in corresponding control commands for the drive unit 170 of the robot 100. The robot control in this case is continually corrected based on the information on the robot environment detected with the sensor unit 120. For example, a desired degree of accuracy, with which the robot follows the path P, can be specified. Methods are known for controlling a robot 100 along a path. For example, a shape of the contour-following run can be used to follow a path, in a manner similar to what was described in greater detail previously for following a contour V of a virtual obstacle with a robot shape simplified down to a virtual point.

Path planning is generally based on map data which describes the operational area more or less completely. The accuracy of the detected details is frequently reduced in these global maps in order to limit the memory requirements and/or the complexity of calculations. Examples of such maps include:
feature maps which may represent the contours of obstacles in the shape of points, lines, and/or surfaces;
grid maps, in which the surface of the operational area is subdivided into individual cells and each cell can be marked as to whether it is occupied by an obstacle or is free to be traversed;
topological maps containing information which connects characteristic points and/or areas of the operational area that can be traveled by the robot.
   Methods for path planning are known for these maps and can be combined as desired.

For the control of the robot along the path, the robot may have a second map and/or second form of map data containing more details and current environment information detected with the sensors from the sensor unit 120. In particular, current information on the environment can be entered into this second map with a high degree of accuracy while the robot moves along the path P. The information entered into the second map can then be deleted after a certain amount of time in order to reduce the memory requirements and the processing complexity. Alternatively, the content of information of the second map can be reduced after a certain time through interpretation and/or simplification, whereby the memory requirements and the processing complexity are likewise reduced.

Based on the second map and the environment information detected with the sensors of the sensor unit 120, it can be determined in some situations, for example, that continued following of the planned path may lead to a collision with at least one obstacle H. Particularly the complete shape of the robot is considered for this. The determination that the planned path cannot be traveled without collision due to an obstacle can also take place by means of detecting an actual collision.

One reason for this potential pending collision may particularly be that the simplified virtual shape 101 of the robot 100 would not collide with the obstacle (virtual) and only this simplified shape was considered during planning. Other reasons that particularly can be considered as well with round robots may be the following: incorrect or imprecise map data, limited accuracy in planning large-scale movements of the robot, change in position of an obstacle (e.g. through the use of a chair), and/or a new obstacle.

Once such a pending collision has been detected, the robot can react to this so as to avoid the collision. In doing so, the complete contour of the shape of the robot, for example, can be considered. For example, the control unit 150 can provide control in a contour-following mode such that it follows the contour of the obstacle until the robot is again on the originally planned path, a target point can be reached, or a terminate condition is fulfilled.

For example, an additional target point can be set before the start of the contour-following mode. This can be part of the originally planned path such that the robot can follow it further starting from this point. The additional target point is set after the obstacle to be avoided (to the extent possible). The target point is then reachable, for example, when there is no obstacle between the robot and the target point, and the robot can rotate to the target point without collision.

A terminate condition is, for example, that the target point is not reachable because it is within the obstacle. A further terminate condition may be that the distance between the robot and the target point becomes greater than a definable value and/or that the distance between the robot and the original path becomes greater than a definable value. The contour of the obstacle would thus lead the robot unusually far away from its original course. The definable value of the maximum distance is, for example, the width of the robot or double the width of the robot. A further terminate condition is, for example, the time needed and/or the path traveled during the contour-following run.

Once a terminate condition has been fulfilled, the robot stops and checks whether there is a different path from its current position to the target point. To this end, the information is included in the map data that the previously planned path could not be successfully traveled and the position at which and/or area in which the interruption and the cancellation of the movement along the path P occurred. In particular, the information is stored when a path can be traversed for the simplified shape 101 but not for the complete shape of the robot for future path planning with the simplified virtual shape of the robot.

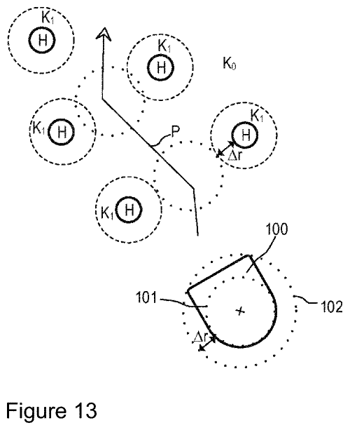

Path planning of a path P may also be “pessimistic” in nature, wherein the robot always reaches the target with planning based on an ideal map (without errors or limited accuracy). This occurs, for example, due to the selection of the simplified virtual shape of the robot as an outline of the robot. This means that all points of the robot are completely in the circle and the center corresponds to the central point (cf. also FIG. 13, outline 102). Thus, a rotation of the robot in place is possible at any point on the path P. In doing so, the virtual shape 101 of the robot may be broader than the actual robot 100, whereby bottlenecks between two obstacles are not traveled.

Alternatively or additionally, the planning of a path P may be “optimistic” in nature. In this case, a circular shape is assumed for the simplified virtual contour, the diameter of said shape corresponding to the width of the robot. This hereby ensures that the robot moves between and through at least two obstacles when the path leads through the center thereof. It should be noted that this only applies to ideal map data. In reality, it is possible that it is determined upon arrival in front of the two obstacles that there is not enough space to follow the path between the two obstacles. In addition, it is possible when the shape of the robot is complex that the necessary rotations cannot be executed in order to follow the planned path P.

The disadvantage of the pessimistic approach is that no path is found from a starting point to a target point in some environments and/or maps corresponding thereto, even though it would be possible in practice. The disadvantage of the optimistic approach is that paths are found which in reality cannot be traversed by the robot or only with difficulty. Any stages between the optimistic and the pessimistic approach can be selected by means of the specific selection of the simplified virtual contour.

Path planning in this case can take place by means of a suitable combination of the approaches mentioned (optimistic, pessimistic). For example, initially pessimistic planning can occur. If this is not successful, optimistic planning is implemented in order to check whether there is even a potential path. For example, one pessimistic and one optimistic planning simulation can be implemented in order to compare the results with one another. The planned paths can be evaluated, for example, according to definable criteria, and the path is selected that has the best evaluation (e.g. the lowest “costs”). The definable criteria may consider, for example, the length of the path and/or its distance away from obstacles. For example, if the pessimistic planning leads to a path that is only “insignificantly longer” than the optimistic planned path, the pessimistic path can be selected. “Insignificantly longer” in this case may mean a fixed potential detour of, for example, 0.1 m to 10 m and/or a fixed factor of, for example, 1.5-3 times as long. Optionally, further planning simulations with other variants of the virtual shape can be considered in the comparison.

Alternatively, the pessimistic (e.g. first virtual robot shape, which completely includes the robot) and the optimistic approach (e.g. second virtual robot shape, which does not fully include the robot) can be combined in one planning approach. A simple example of this is shown in FIG. 13, in which the situation shown is very similar to the situation in FIG. 12, diagram (a). In this case, different sub-sections of a map of the robot are assigned costs (e.g. cost value on a scale), wherein these costs particularly consider the actual shape of the robot 100 and are set at a higher level, for example, when the robot is potentially limited in its rotation (about its kinematic center) due to an obstacle in the vicinity. In the example from FIG. 13, the costs at positions with a distance less than or equal to Δr are equal to K₁ and in other sub-sections K₀ (K₁>K₀), wherein, for example, the value Δr is the difference between the radius of the “large” outline 102 of the robot 100 (virtual shape as a worst-case assessment) and the radius of the simplified robot shape 101. As shown in FIG. 12, the actual path planning can then be based on the simplified virtual robot shape 101 (e.g. circle with a radius that is half the width of the robot, cf. FIG. 11), which enables the reduction of path planning down to one point (cf. FIG. 12). For example, with such cost-based planning, the costs of a path can be established depending on the distance away from obstacles (as mentioned, if an obstacle is close, rotation is usually limited and consequently the cost value is higher in the respective sub-section of the map).

A path between two obstacles close to one another (optimistic) can be assigned higher costs than the path associated with a detour around the obstacles (pessimistic). Due to the selection of costs for the movement of the robot close to obstacles, the acceptable detour is defined and can be considered a result of an optimization task. The advantage of such an approach is that it always provides a result when the optimistic approach leads to a path. At the same time, the path thusly obtained is always a balance between the bottlenecks between the starting point and the target point and the necessary detours in order to avoid the bottlenecks. In the example according to FIG. 13, costs K₀ and K₁ can be discrete values (e.g. K₀=0, K₁=1); alternatively, K₁ can also increase as the distance away from an obstacle H decreases. Obstacles can be considered in this approach in that the costs in areas occupied by an obstacle can be selected to be essentially infinitely great.

If a potential collision with an obstacle H is detected during the run of the robot 100 along its path P, the robot can follow the path up to the obstacle (e.g. with consideration of a safety distance) and then directly switch into contour-following mode. Alternatively, the robot can check whether there is a deviating path passed the obstacle which leads back to the original path P.

In particular, the reaction to a potential collision with an obstacle H can take place as a function of the current task of the robot. For example, with an autonomous mobile robot for processing a surface area, the robot can move as close as possible to the obstacle during processing of a planned robot path and then process the surface along the contour of the obstacle. On the other hand, the same robot can travel through areas that are not intended to be processed during a run to an assigned area to be processed or a base station. In this case, a deviating path around the obstacle H can be determined such that the target (e.g. assigned area, base station) is reached more quickly.

In order to determine the deviating path, the complete shape of the robot 100 can be considered directly. Alternatively or additionally, preplanning can occur based on the simplified virtual shape 101 of the robot 100 as to whether a path around the obstacle is even possible. This is particularly helpful when the path would lead through two obstacles close together. In this case, it can be determined that the simplified virtual shape 101 could not follow the originally planned path, which is why more large-scale detouring and associated path planning is necessary. In this case, it can be determined that the simplified virtual shape 101 can follow the originally planned path through the two obstacles. In this case, the robot can move between the obstacles and through, for example with the contour-following mode, with consideration of the complete shape of the robot.

The result of the determination of the deviating path may be that the obstacle can be safely bypassed at a certain distance. This is particularly the case for a single obstacle located in an otherwise extensively free area. A further potential result is that the obstacle can be avoided in a contour-following mode (in that the complete shape of the robot is considered).

Particularly when using a contour-following mode based on map data, one variant for checking whether the robot can bypass the obstacle and find its way back to the original path P is the pre-calculation (or simulation) of the course of the contour-following run. This can also be used, inter alia, when there are various options of the start of the contour-following mode (particularly avoidance to the right or left) in order to find the path most quickly leading back to the target.

Map data which describe the environment with great accuracy are used for planning the deviating path. This takes place, for example, by means of the information on the environment collected in the second map. In order to limit the use of resources for memory requirements and computing capacity, the planning of the deviating path can be limited to a small area (e.g. circle around the robot with a radius of 0.5 to 2 m).

1. A method for controlling an autonomous mobile robot which can operate in a first and at least one second contour-following mode, wherein, in each of the contour-following modes, the robot maintains a substantially constant distance away from a contour while the robot moves along the contour; the method comprises:
starting the first contour-following mode, wherein the robot follows the contour in a first direction of travel;
detecting a dead-end situation, in which continued following of the contour is not possible without collision in the first contour-following mode;
starting a second contour-following mode, wherein the robot follows the contour in a second direction of travel; and
specifying a criterion, upon the fulfillment of which the second contour-following mode is terminated, and ongoing evaluation of the criterion while the robot is in the second contour-following mode.

2. The method according to claim 1,
wherein the contour-following modes comprise at least two parameters, wherein the at least two parameters comprise the direction of travel, the contour-following distance, and optionally one of the following parameters: the side of the robot facing the contour, a safety distance, the robot shape being considered for detecting a pending collision, the rules according to which the movement takes place along the contour, and
wherein two different corrective-following modes differ by at least one parameter.

3. The method according to claim 1, wherein the detecting of the dead-end situation comprises:
detecting that a movement of the robot along the contour as well as a rotation of the robot are not possible without collision, wherein, during detection, location-based information stored in a map of the robot is considered.

4. The method according to claim 1,
wherein a third contour-following mode is started in the event that another dead-end situation is detected in the second contour-following mode, and
wherein a criterion, upon fulfillment of which the third contour-following mode is terminated, is specified and the criterion is continually evaluated while the robot is in the third contour-following mode.

5. The method according to claim 4,
wherein the third contour-following mode differs from the second contour-following mode by the following parameter: the side of the robot facing the contour.

6. The method according to claim 1,
wherein the first contour-following mode is continued when the second contour-following mode is terminated due to fulfillment of the specified criterion.

7. The method according to claim 1, wherein the contour is formed by a virtual obstacle that is not real but that is contained in a map of the robot.

8. The method according to claim 1,
wherein the criterion, upon the fulfillment of which the second contour-following mode is terminated, contains the option of executing a particular movement.

9. The method according to claim 8, wherein the particular movement comprises at least one of the following:
a rotation about a particular angle, and
a translational movement, over a particular distance.

10. The method according to claim 1, wherein the evaluation of the criterion comprises:
automatic planning of a collision-free robot movement according to definable rules;
executing a planned robot movement;
checking whether the planned robot movement can be executed without collision.

11. The method according to claim 10,
wherein the planning of the collision-free robot movement considers location-based information related to obstacles, said information being stored in a map of the robot.

12. The method according to claim 10,
wherein the automatic planning of a robot movement according to definable rules comprises:
planning a rotation and a subsequent translational movement such that a point of an obstacle is a particular distance away from the robot after implementation of the movement.

13. The method according to claim 12,
wherein the rotation takes place about an angle which is greater than a definable minimum angle.

14. The method according to claim 1,
wherein the specifying of the criterion, upon the fulfillment of which the second contour-following mode is terminated, or the evaluating of the specifying of the criterion takes place while considering location-based information stored in a map of the robot.

15. The method according to claim 1,
wherein the criterion, upon the fulfillment of which the second contour-following mode is terminated, is updated during implementation of the second contour-following mode.

16. A method for controlling an autonomous mobile robot in a contour-following mode, wherein the robot substantially follows a contour at a contour-following distance; the method comprises the following in the contour-following mode:
evaluating at least three different basic movements by at least one definable criterion, and
executing one of the three basic movements based on the evaluation thereof,
wherein a first of the three basic movements is a purely translational movement of the robot,
wherein a second of the three basic movements contains a rotation of the robot toward the contour, and
wherein a third of the three basic movements contains a rotation of the robot away from the contour.

17. The method according to claim 16,
wherein, during each evaluation of at least two of the basic movements, the particular movement is selected which leads the robot closer to the contour or less far away from the contour.

18. The method according to claim 16, wherein a previously executed basic movement is considered during the evaluation of a basic movement.

19. The method according to claim 18, wherein there is consideration during the evaluation that the third basic movement should not be selected and vice versa, after execution of the second basic movement.

20. The method according to claim 16,
wherein the evaluation of the basic movements considers at least one of the following criteria:
the basic movement is possible without collision with an obstacle;
the distance of the robot away from obstacles during and/or after the movement; and
the collision-free feasibility of a further, for example translational, movement after execution of the respective basic movement.

21. The method according to claim 20, wherein the obstacles may be different types and a type of an obstacle is considered in the evaluation.

22. The method according to claim 21, wherein obstacles of a first type include obstacles detected by a sensor unit of the robot, and obstacles of a second type are not real but virtual obstacles contained in a map of the robot.

23. The method according to claim 16, wherein the second and the third basic movements contain rotations in place.

24. The method according to claim 16, which further comprises:
detecting that none of the three basic movements can be executed according to a definable criterion,
wherein provided a detection that none of the three basic movements can be executed, the robot changes the direction of travel and/or the side of the robot facing a contour and/or the evaluation criteria.

25. The method according to claim 24,
wherein the robot has a preferred direction of travel and, upon a change in the direction of travel into the direction of travel opposite the preferred direction of travel, an evaluation criterion is specified, upon the fulfillment of which there is a switch back into the preferred direction of travel.

26. The method according to claim 16, which further comprises:
wherein the at least three basic movements are defined by several parameters, and the parameters are determined with the aid of an optimization process.

27. The method according to claim 26, wherein the parameters are determined at least partially automatically by an automated learning process such that the robot executes desired definable movement patterns in certain definable situations.

28-53. (canceled)
